(19) United States
(12) Patent Application Publication
(10) Pub. No.: US 2007/0272211 A1
(43) Pub. Date: Nov. 29, 2007

(54) Method for Monitoring the Exhaust Gas Recirculation of an Internal Combustion Engine

(75) Inventor: Uwe Kassner, Moeglingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/561,636

(22) PCT Filed: Jun. 18, 2004
(86) PCT No.: PCT/DE04/01267

§ 371 Date: Mar. 26, 2007

(30) Foreign Application Priority Data
Jun. 20, 2003 (DE) 103 27 691.2

(51) Int. Cl. F02M 25/07; F02B 47/08; G01M 19/00; F02M 7/00

(52) U.S. Cl. 123/435; 123/568.16; 73/118.1

(57) ABSTRACT

A method for monitoring the exhaust gas recirculation of an internal combustion engine by pressure sensing, in which exhaust gas is recirculated from an outlet side of a combustion chamber assemblage via an exhaust gas recirculation conduit to an inlet side of the combustion chamber assemblage. Reliable monitoring of the exhaust gas recirculation with relatively little complexity is achieved by the fact that a pressure curve is sensed in at least one combustion chamber and a thermodynamic parameter is ascertained therefrom as an actual value; that a setpoint value of the parameter, which setpoint value takes into account the current operating point of the internal combustion engine, is made available, and a deviation between setpoint value and actual value is determined; and that a datum regarding the current exhaust gas recirculation state, as compared with its normal state, is obtained from the deviation.

The present invention refers to a method for monitoring the exhaust gas recirculation of an internal combustion engine by pressure sensing, in which exhaust gas is recirculated from an outlet side of a combustion chamber assemblage via an exhaust gas recirculation conduit to an inlet side of the combustion chamber assemblage.

### BACKGROUND INFORMATION

A method of this kind is described in DE 42 03 235 A1. With this known method, pressure values are successively sensed in an intake duct by way of a failure diagnosis apparatus of an exhaust gas recirculation control device, and the successive pressure value differences are accumulated. From the accumulated value, a failure diagnosis of the exhaust gas recirculation control device is performed by comparison with a predetermined value. With an indirect method of this kind, careful adaptations must be performed for each operating point of the internal combustion engine in order to prevent misdiagnoses. The necessary complexity additionally results in higher costs.

In a further method of this kind proposed in U.S. Pat. No. 5,664,548, pulse amplitudes of the exhaust gas flow are sensed at the outlet side of the internal combustion engine in order to ascertain the exhaust gas recirculation state. This indirect procedure is also relatively complex. Further sensors are disadvantageous in this context; in particular, sensors that are exposed to the exhaust gas flow are subjected to large temperature stresses and malfunctions due to particle deposition.

Exhaust gas recirculation (EGR) is understood in the present case to be the metered introduction of exhaust gas from the output side of the internal combustion engine into the intake region. For this purpose, an exhaust gas recirculation valve is usually controlled by the existing control device of the internal combustion engine as a function of various operating parameters of the internal combustion engine. If, however, the valve does not meter the expected exhaust gas mass flow (for example, because the valve does not open completely due to contamination and deposits or cross-section reductions in the exhaust gas pathway from the exhaust-gas side of the internal combustion engine to the air intake side), permissible limit values for exhaust emissions are exceeded and non-optimum control signals (e.g. ignition timing) are ascertained by the control apparatus.

In addition to the methods cited above for monitoring exhaust gas recirculation, a variety of other basic principles are also known. These include measurement and monitoring of the temperature changes brought about by active exhaust gas recirculation, a temperature sensor being located between the exhaust gas recirculation valve and the intake region, as described e.g. in U.S. Pat. No. 6,085,732. Measurement and monitoring of the gas mass flow brought about by active exhaust gas recirculation has also been proposed.

DE 42 24 219 A1 proposes to monitor the nitrogen oxide in the exhaust gas using an NOx sensor, and to draw conclusions as to the rate of exhaust gas recirculation; while DE 42 16 044 A1 discloses observation of the rise in the combustion misfire rate with increasing opening of the exhaust gas recirculation valve.

It is the object of the invention to make available a method of the kind cited initially with which the most reliable possible monitoring of exhaust gas recirculation can be achieved with the least possible complexity.

### ADVANTAGES OF THE INVENTION

This object is achieved with the features of claim 1. Provision is made in this context for a pressure curve to be sensed in at least one combustion chamber, and a thermodynamic parameter to be ascertained therefrom as an actual value; for a setpoint value of the parameter, which setpoint value takes into account the current operating point of the internal combustion engine, to be made available, and for a deviation between setpoint value and actual value to be determined; and for a datum regarding the current exhaust gas recirculation state, as compared with its normal state, to be obtained from the deviation.

With these actions a direct method is obtained; the system for monitoring exhaust gas recirculation requires no additional sensors, and the combustion process is analyzed directly. The method makes use of the existing control device of the internal combustion engine, which is connected to transducers for combustion chamber pressure or cylinder pressure for at least one, for example each, of the cylinders of the internal combustion engine that are to be monitored. The control device also, in usual fashion, acts on the exhaust gas recirculation valve in order to establish the exhaust mass flow necessary for optimum operation of the internal combustion engine. The change in cylinder pressure, and, if applicable, variables derived therefrom, are used as the input signal for a variety of control functions in the control device. Output signals of the control system are, for example, control signals for fuel metering and for controlling ignition of the fuel-air mixture.

The method is based on the known dependence of the combustion process on the relative amount of recirculated exhaust gas as a proportion of the total air and fuel charge in each cylinder. The larger this relative exhaust gas proportion, the longer the time needed for conversion of the fuel during combustion. This is explained by the nature of the exhaust gas as an inert gas, which makes no contribution to the chemical reaction between fuel and atmospheric oxygen. Fuel conversion is determined by applying thermodynamic calculations. An important input variable in the thermodynamic calculation is the measured cylinder pressure. The result of this calculation for (as a rule) one complete combustion cycle is then compared in the control device with a setpoint value. The setpoint value is preferably ascertained (as a rule once, on the test stand) during determination of the control parameters for the internal combustion engine for different relative exhaust gas recirculation proportions, at operating points of the internal combustion that may be expected for monitoring (e.g. engine speed and air charge, as well as amount of activation of the exhaust gas recirculation valve).

An advantageous embodiment of the method for reliable monitoring of exhaust gas recirculation consists in the fact that a time difference or a crankshaft angle difference between a percentage energy conversion point and a reference time or reference angle known in the control device is taken as the basis for the thermodynamic parameter.

A simple procedure with reliable measurement is promoted by the fact that the pressure curve is sensed by sampling at fixed crankshaft angles or time intervals, and the sampled pressure values are stored as a data sequence during at least a portion of one combustion cycle.

A procedure that is advantageous for evaluation is also achieved by the fact that the thermodynamic parameter is ascertained during at least a portion of one combustion cycle, on the basis of the pressure curve, from a combustion curve in which the total quantity of heat released is calculated, or from a heat curve in which the quantity of heat conveyed to the combustion gas is calculated.

For determination of the thermodynamic parameter, provision is advantageously made for the heat curve to be calculated on the basis of the relationship dQh=dU+p*dV, where dQh denotes the quantity of heat conveyed, dU the increase in the internal energy of the combustion gas, and p*dV the mechanical work delivered; and for an energy conversion percentage to be ascertained from the conveyed quantity of heat dQh by integration over the crankshaft angle.

Specifically, a favorable process sequence results from the fact that the percentage energy conversion point is calculated according to the formula
Qᵢ=[n/(n−1)]*pᵢ*(Vᵢ₊₁-Vᵢ₋₁)*[1/(n−1)]+Vᵢ*(pᵢ₊₁-pᵢ₋₁),
where n denotes the polytropic exponent, p the pressure in the combustion chamber, V the cylinder volume, and i a running index of the sampled and stored cylinder pressure from the beginning to the end of a calculation interval, or from a formula derived from that formula; and that the energy conversion percentage is ascertained by integration of the quantities of heat Qᵢ over one complete working cycle after determination of the 100% energy conversion, and the crankshaft angle corresponding to the energy conversion percentage is determined therefrom.

Reliable monitoring of exhaust gas recirculation is achieved, for example, by the fact that the 50% energy conversion point is taken as the basis for the percentage energy conversion point.

Also advantageous for the monitoring of exhaust gas circulation are the features according to which the deviation between setpoint value and actual value is compared with a positive and a negative limit value that take into account the tolerances of the parameter calculation and of the setpoint value.

Various possibilities for sensing the pressure curve consist in the fact that the pressure curve is determined directly by way of a sensor arranged in at least one combustion chamber, or indirectly.

Further advantageous embodiments of the method result from the fact that the exhaust gas recirculation data that are ascertained are evaluated in the control device for a fault diagnosis with fault storage and/or fault display, and/or for control purposes, in particular readjustment of an exhaust gas recirculation valve.

### DRAWINGS

The invention will be explained in further detail below on the basis of exemplifying embodiments with reference to the drawings, in which:

FIG. 1 is a schematic depiction of portions of an internal combustion engine that are essential in the present instance; and

FIG. 2 is a flow chart of the monitoring of an exhaust gas recirculation process.

### EXEMPLARY EMBODIMENTS

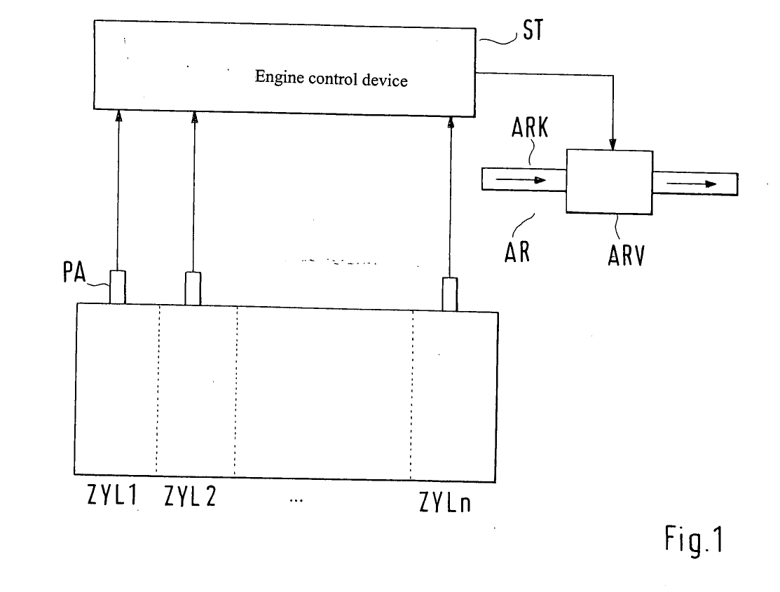

FIG. 1 schematically depicts a cylinder assemblage of an internal combustion engine having cylinders ZYL1, ZYL2, . . . ZYLn, which is connected from its output side (not depicted) to its input side (also not depicted) or intake region via an exhaust gas recirculation conduit ARK having an exhaust gas recirculation valve ARV arranged therein for exhaust gas recirculation AR. Usually one such exhaust gas recirculation AR is provided jointly for all cylinders ZYL1 . . . ZYLn, although an individual exhaust gas recirculation AR via respective exhaust gas recirculation conduits ARK is also conceivable. Cylinders ZYL1 . . . ZYLn are equipped with respective pressure transducers PA for the combustion chamber pressure or cylinder pressure, the signals of which transducers are conveyed to a control device ST for processing, evaluation, and optionally activation of exhaust gas recirculation valve ARV. Control device ST is a usual engine control device that performs a plurality of internal combustion engine monitoring and control functions and is equipped, inter alia, with suitable memory devices in order, for example, to store predefined values and, for example, to perform a fault diagnosis.

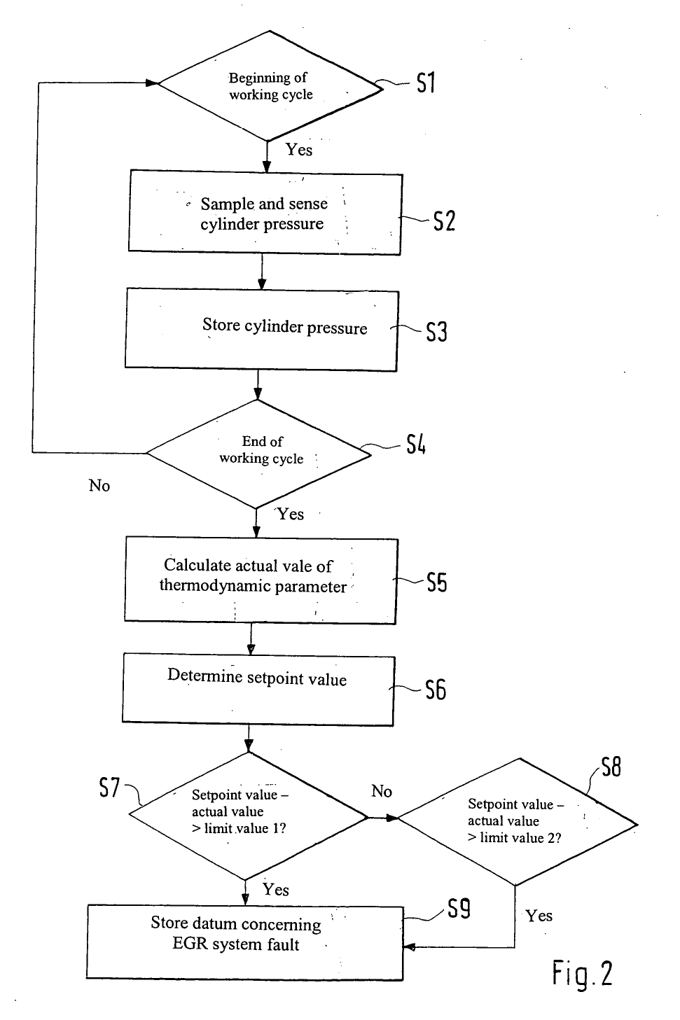

FIG. 2 shows a process sequence for monitoring exhaust gas recirculation AR. After the beginning of a working cycle in a step S1 (e.g. injection time or ignition time), the cylinder pressure is sampled and sensed at, preferably, a fixed crankshaft angle in a step S2, and is stored in a step S3. A step S4 then ascertains whether the working cycle is complete (e.g. at a specific crankshaft angle or decreased cylinder pressure). If the working cycle is not complete, the previous steps are repeated until the end of the working cycle is identified. The actual value of a thermodynamic parameter that is characteristic of exhaust gas recirculation is then ascertained in a step S5, and in a step S6 the setpoint value corresponding to the current operating parameters of the internal combustion engine is made available from a memory table or a previously stored curve. A subsequent comparison of setpoint value and actual value in a step S7 then determines whether the deviation is greater than a predefined limit value. If that is not the case, a step S8 determines whether the deviation between the setpoint value and actual value falls below a further predefined limit value. If the value found in step S7 or step S8 exceeds or falls below the limit value, respectively, then in a step S9 a datum concerning a fault in exhaust gas recirculation or in the exhaust gas recirculation system is stored. Using this datum, a diagnostic display can then be controlled by way of the control device; or further or different control functions, for example readjustment of exhaust gas recirculation valve ARV for adaptation to a sooted exhaust gas recirculation conduit, can be initiated.

The setpoint value that is stored as the parameter in the control device takes into account the current operating point of the internal combustion engine, e.g. in accordance with the engine speed, the air charge, or an exhaust gas recirculation rate that has been set. The two predefined limit values take into account tolerances in parameter calculation and in the setpoint value.

In order to increase evaluation reliability, execution usually waits for a specific number of exceedances before indicating abnormal exhaust gas recirculation AR or performing other control functions.

In an expansion of the control function or diagnostic function, the activation of exhaust gas recirculation valve ARV by the control device can be influenced in such a way that the deviation between the setpoint value and actual value is controlled out. It is thereby possible, for example, to compensate for increasing contamination of exhaust gas recirculation valve ARV or of exhaust gas recirculation conduit ARK, or of the connecting lines.

The aforesaid thermodynamic parameter is selected in such a way that it describes the process of combustion over time. Variables known per se for this are the so-called combustion curve, which calculates the total quantity of heat released, and the so-called heat curve, which calculates the quantity of heat conveyed to the gas. The heat curve is easier to calculate, for example because wall heat losses are not taken into account, and is determined by the relationship
dQh=dU+p*dV,
where dQh denotes the quantity of heat conveyed, dU the increase in the internal energy of the gas, and p*dV the mechanical work delivered. The energy conversion percentage over a crankshaft angle α is ascertained from the quantity dQh by integration over the crankshaft angle. From a variety of experiments it is known that, for example, the crankshaft angle a_{E50%} at which 50% of the energy conversion has taken place exhibits a correlation with the relative proportion of exhaust gas recirculation in terms of cylinder charge (exhaust gas recirculation rate). The 50% energy conversion cannot itself, however, be unequivocally associated with the exhaust gas recirculation rate.

To arrive at an unequivocal association, in the present case the thermodynamic parameter is determined as the difference between the 50% energy conversion point and the currently ascertained ignition angle α_{z}, using the relationship
Δa=α_{E50%}−αa_{z}.

With this magnitude, the relative exhaust gas recirculation rate can be ascertained. The correlation between the exhaust gas recirculation rate and the crank angle difference Δα is stored in the control device of the internal combustion engine in the form of data, i.e. as a characteristics diagram or a function Δαₛₑₜₚₒᵢₙₜ=f(EGR_rate). This function can be supplemented, if applicable, with further operating parameters.

For the activation of exhaust gas recirculation valve ARV as set by control device ST, the pertinent parameter Δαₛₑₜₚₒᵢₙₜ is ascertained as a setpoint value from the stored data for the relevant combustion cycle. Control device ST additionally calculates, from the cylinder pressure signal or the data sequence of the sampled pressure curve, the 50% ignition angle α_{E50%} that corresponds to the 50% energy conversion point and that, after subtraction of the current ignition angle α_{z}, yields actual value Δα_{actual}.

In internal combustion engines without spark ignition, thermodynamic parameter Δa can also be accomplished, for example, by replacing ignition angle α_{z}. One possible implementation of such a replacement variable is, for example, the angle at which fuel injection begins.

A simple capability for calculating the 50% crankshaft angle (50% energy conversion angle) in the control device results from the formula
Qᵢ=[n/(n−1)]*pᵢ*(Vᵢ₊₁-V₁₋₁)+[1/(n−1)]*Vᵢ*(pᵢ₊₁-pᵢ₋₁),
where Qᵢ denotes the quantity of heat, n the polytropic exponent, p the cylinder pressure, V the respective cylinder volume, and i the running index of the sampled and stored cylinder pressure from the beginning to the end of the calculation interval, which interval need not necessarily encompass the entire combustion cycle. A limitation to a relevant portion of the combustion cycle in the region of energy release from the fuel can be applied.

After integration of the quantities of heat Qᵢ over the entire working cycle, i.e. to the point where 100% energy conversion is determined, the crankshaft angle a_{E50%} corresponding to 50% energy conversion can be identified. Similarly, it is also conceivable to identify a crankshaft angle a_{Ek%} that corresponds to a k % energy conversion.

For the above-described determination of the thermodynamic parameter, it is sufficient to sense the pressure curve at only one cylinder, but pressure curves can also be sensed at several, in particular all, cylinders ZYL1 . . . ZYLn in order to calculate the thermodynamic parameter.

1.-10. (canceled)

11. A method for monitoring an exhaust gas recirculation of an internal combustion engine by pressure sensing, comprising:
recirculating an exhaust gas from an outlet side of a combustion chamber assemblage via an exhaust gas recirculation conduit to an inlet side of the combustion chamber assemblage;
sensing a pressure curve in at least one combustion chamber;
ascertaining a thermodynamic parameter therefrom as an actual value;
making available a setpoint value of the thermodynamic parameter, the setpoint value taking into account a current operating point of the internal combustion engine; and
determining a deviation between the setpoint value and the actual value is determined; and
obtaining from the deviation a datum regarding a current exhaust gas recirculation state, as compared with a normal state thereof.

12. The method as recited in claim 11, wherein:
the thermodynamic parameter is ascertained based on one of a time difference and a crankshaft angle difference between a percentage energy conversion point and one of a reference time and a reference angle known in a control device.

13. The method as recited in claim 11, wherein:
the pressure curve is sensed by sampling at one of fixed crankshaft angles and time intervals, and
sampled pressure values are stored as a data sequence during at least a portion of one combustion cycle.

14. The method as recited in claim 11, wherein:
the thermodynamic parameter is ascertained during at least a portion of one combustion cycle, on the basis of the pressure curve, from one of:
a combustion curve in which a total quantity of heat released is calculated, and
a heat curve in which a quantity of heat conveyed to a combustion gas is calculated.

15. The method as recited in claim 14, further comprising:
calculating the heat curve on the basis of the relationship dQh=dU+p*dV, where dQh denotes a quantity of heat conveyed, dU denotes an increase in an internal energy of the combustion gas, and p*dV denotes a mechanical work delivered; and
ascertaining an energy conversion percentage from the conveyed quantity of heat dQh by integration over the crankshaft angle.

16. The method as recited in claim 12, further comprising:
calculating the percentage energy conversion point according to the formula Qᵢ=[n/(n−1)]*pᵢ*(Vᵢ₊₁-Vᵢ₋₁)*[1/(n−1)]+Vᵢ*(pᵢ₊₁-pᵢ₋₁), where n denotes a polytropic exponent, p denotes a pressure in the combustion chamber, V denotes a cylinder volume, and i denotes a running index of a sampled and stored cylinder pressure from a beginning to an end of a calculation interval;
ascertaining an energy conversion percentage by integration of a quantity of heat Qᵢ over one complete working cycle after determination of a 100% energy conversion; and
determining a crankshaft angle corresponding to the energy conversion percentage.

17. The method as recited in claim 12, wherein a 50% energy conversion point is taken as the basis for the percentage energy conversion point.

18. The method as defined in claim 12, further comprising:
comparing the deviation between the setpoint value and the actual value with a positive limit value and a negative limit value that take into account tolerances of the parameter calculation and of the setpoint value.

19. The method as recited in claim 11, wherein the pressure curve is determined one of indirectly and directly by way of a sensor arranged in at least one combustion chamber.

20. The method as recited in claim 11, further comprising:
evaluating the datum in a control device for at least one of a control purpose and a fault diagnosis with at least one of a fault storage and a fault display, corresponding to a readjustment of an exhaust gas recirculation valve.
